(19) United States
(12) Patent Application Publication
(10) Pub. No.: US 2023/0287821 A1
(43) Pub. Date: Sep. 14, 2023

(54) TUBULAR MEMBER FOR EXHAUST GAS TREATMENT DEVICE AND METHOD OF MANUFACTURING TUBULAR MEMBER FOR EXHAUST GAS TREATMENT DEVICE

(71) Applicant: NGK Insulators, Ltd., Nagoya-City (JP)

(72) Inventor: Daichi TANAKA, Komaki City (JP)

(73) Assignee: NGK Insulators, Ltd., Nagoya-City (JP)

(21) Appl. No.: 18/062,758

(22) Filed: Dec. 7, 2022

(30) Foreign Application Priority Data
Mar. 9, 2022 (JP) 2022-036457

(51) Int. Cl. F01N 3/20; F01N 13/16; F01N 13/18; F01N 3/28; B01D 53/94; C23D 5/02

(52) U.S. Cl. CPC F01N 3/2026; F01N 13/16; F01N 13/18; F01N 3/2839; B01D 53/94; C23D 5/02

(57) ABSTRACT

Provided is a tubular member for an exhaust gas treatment device, including: a tubular main body made of a metal; an insulating layer arranged at least on an inner peripheral surface side of the tubular main body; and an intermediate layer arranged between the tubular main body and the insulating layer, wherein the insulating layer contains glass, and wherein the intermediate layer is at least not identical in composition to the insulating layer.

### CROSS-REFERENCE TO RELATED APPLICATION

The present application claims priority from Japanese Application JP 2022-36457 filed on Mar. 9, 2022, the content of which is hereby incorporated by reference into this application.

### BACKGROUND OF THE INVENTION

### 1. Field of the Invention

One or more embodiments of the present invention relate to a tubular member for an exhaust gas treatment device, and to a method of manufacturing a tubular member for an exhaust gas treatment device.

### 2. Description of the Related Art

A catalyst support obtained by causing a support to support a catalyst is used for treatment of a harmful substance in an exhaust gas discharged from a vehicle engine. In this case, there is a problem in that, when a temperature of the catalyst is low at a start of the engine, the temperature of the catalyst is not increased to a predetermined temperature, resulting in a failure to sufficiently purify the exhaust gas. In order to solve such problem, progress is being made in development of an exhaust gas treatment device using an electric heating catalyst (EHC), in which a support having conductivity is energized to cause the support to generate heat, to thereby increase the temperature of the catalyst supported on the support to its active temperature before the start of the engine or at the start of the engine.

In the exhaust gas treatment device, the EHC is typically housed in a tubular member made of a metal (sometimes referred to as “can”). The EHC can be excellent in purification efficiency for the exhaust gas at the start of the vehicle, but electricity leaks from the EHC to surrounding exhaust piping, resulting in a failure such as a reduction in purification efficiency in some cases. In order to solve such problem, in each of Japanese Patent No. 5408341 and Japanese Patent Application Laid-open No. 2012-154316, there is a disclosure that the leakage of electricity is prevented by forming an insulating layer on an inner peripheral surface of the tubular member.

### SUMMARY OF THE INVENTION

However, when exposed to high temperature for a long period of time, the insulating layer is reduced in insulating performance in some cases. The reduction in insulating performance may lead to a failure, such as a reduction in heat generation performance of the EHC or a leakage of electricity.

One or more embodiments of the present invention have been made in view of the foregoing, an object thereof is to provide a tubular member for an exhaust gas treatment device excellent in durability of an insulating property (insulation durability).

According to at least one embodiment of the present invention, there is provided a tubular member for an exhaust gas treatment device, including: a tubular main body made of a metal; an insulating layer arranged at least on an inner peripheral surface side of the tubular main body; and an intermediate layer arranged between the tubular main body and the insulating layer, wherein the insulating layer contains glass, and wherein the intermediate layer is at least not identical in composition to the insulating layer.

In at least one embodiment of the present invention, the tubular main body is formed of ferritic stainless steel.

In at least one embodiment of the present invention, the intermediate layer is formed of an oxide.

In at least one embodiment of the present invention, the intermediate layer is formed of an oxide of at least one element selected from: aluminum; titanium; silicon; zirconium; magnesium; and yttrium.

In at least one embodiment of the present invention, the intermediate layer and the insulating layer each contain a first element, and a content of the first element in the intermediate layer is higher than a content of the first element in the insulating layer.

In at least one embodiment of the present invention, the content of the first element in the insulating layer is 70 mol % or less.

In at least one embodiment of the present invention, the first element is aluminum.

In at least one embodiment of the present invention, the intermediate layer is substantially free of glass.

In at least one embodiment of the present invention, the glass contained in the insulating layer contains silicon, boron, and magnesium.

In at least one embodiment of the present invention, the insulating layer has a thickness of 30 μm or more and 800 μm or less.

In at least one embodiment of the present invention, the intermediate layer has a thickness of 30 μm or less.

In at least one embodiment of the present invention, the intermediate layer has a thickness of 1 μm or less.

According to at least one embodiment of the present invention, there is provided an exhaust gas treatment device, including: an electric heating catalyst support capable of heating an exhaust gas; and the tubular member for an exhaust gas treatment device configured to house the electric heating catalyst support.

According to at least one embodiment of the present invention, there is provided a method of manufacturing the tubular member for an exhaust gas treatment device. A method of manufacturing the tubular member for an exhaust gas treatment device according to a first embodiment includes: applying an intermediate layer-forming material to an inner peripheral surface of a tubular main body made of a metal; and applying a coating liquid for insulating layer formation to the surface having applied thereto the intermediate layer-forming material, followed by firing of the resultant coating film to obtain an insulating layer.

A method of manufacturing the tubular member for an exhaust gas treatment device according to a second embodiment includes applying a coating liquid for insulating layer formation to an inner peripheral surface of a tubular main body made of a metal, the tubular main body containing an intermediate layer-forming component, followed by firing of the resultant coating film to obtain an insulating layer.

### BRIEF DESCRIPTION OF THE DRAWINGS

FIG. 1 is a sectional view for illustrating the schematic configuration of a tubular member to be used in an exhaust gas treatment device according to at least one embodiment of the present invention.

FIG. 2 is a view for illustrating the section taken along the line II-II of FIG. 1.

FIG. 3 is a schematic sectional view for illustrating the schematic configuration of the exhaust gas treatment device according to at least one embodiment of the present invention.

FIG. 4 is a view of the exhaust gas treatment device of FIG. 3 seen from the direction of the arrow IV.

### DETAILED DESCRIPTION OF THE INVENTION

Embodiments of the present invention are described below with reference to the drawings. However, the present invention is not limited to these embodiments. In addition, in the drawings, the width, thickness, shape, and the like of each portion may be schematically illustrated as compared to those in the embodiments in order to provide clearer description, but the drawings are merely examples and do not limit the interpretation of the present invention.

### A. Tubular Member

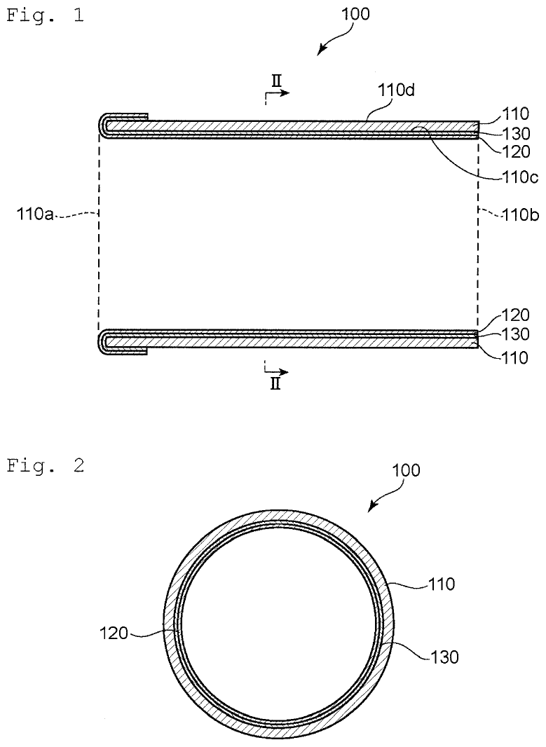

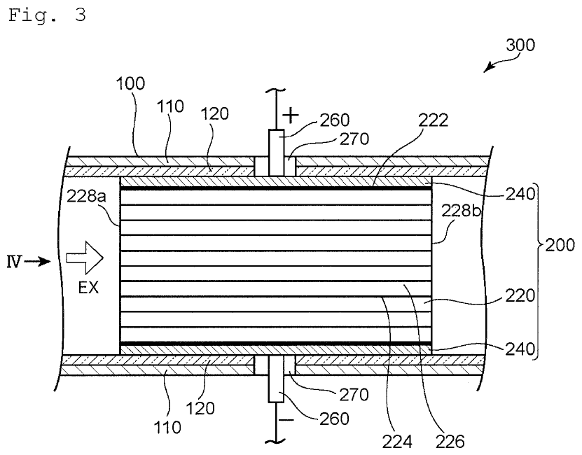

FIG. 1 is a sectional view for illustrating the schematic configuration of a tubular member to be used for an exhaust gas treatment device according to at least one embodiment of the present invention, and FIG. 2 is a view for illustrating the section taken along the line II-II of FIG. 1. A tubular member 100 includes: a tubular main body 110, which is made of a metal and has a cylindrical shape; an insulating layer 120 arranged at least on an inner peripheral surface 110c side of the tubular main body 110; and an intermediate layer 130 arranged between the tubular main body 110 and the insulating layer 120. The region in which the insulating layer 120 is formed may be appropriately set in accordance with the sizes, number, and arrangement of objects to be housed, such as an electric heating catalyst support to be described later, the purposes, and the like. In the illustrated example, the insulating layer 120 is formed over the entirety of the inner peripheral surface 110c of the tubular main body 110, and in an end portion on a first end surface 110a side, the insulating layer 120 is formed from the inner peripheral surface 110c to an outer peripheral surface 110d. Unlike the illustrated example, for example, in the inner peripheral surface 110c of the tubular main body 110, a non-formation region in which the insulating layer 120 is not formed may be arranged in an end portion on a second end surface 110b side.

The insulating layer 120 is arranged on the tubular main body 110 via the intermediate layer 130, and the intermediate layer 130 may be arranged corresponding to the region in which the insulating layer 120 is formed. When such intermediate layer 130 is arranged, high insulation durability can be achieved. Specifically, the arrangement of the intermediate layer 130 can suppress the oxidation of the tubular main body 110 made of a metal to suppress the leakage of a component (e.g., iron) contained in the tubular main body 110, and can suppress the erosion of the insulating layer 130 by such component.

The sectional shape of the tubular main body 110 perpendicular to its length direction, which is a circle in the illustrated example, may be appropriately designed in accordance with purposes. For example, the sectional shape may be a polygon (e.g., a quadrangle, a hexagon, or an octagon) or an ellipse.

The thickness of the tubular main body 110 may be, for example, from 0.1 mm to 10 mm, from 0.3 mm to 5 mm, or from 0.5 mm to 3 mm from the viewpoint of endurance reliability. The length of the tubular main body 110 may be appropriately set in accordance with the sizes, number, and arrangement of objects to be housed, such as an electric heating catalyst support to be described later, the purposes, and the like. The length of the tubular main body 110 may be, for example, from 30 mm to 600 mm, from 40 mm to 500 mm, or from 50 mm to 400 mm. In at least one embodiment of the present invention, the length of the tubular main body 110 is designed to be larger than the length of an electric heating catalyst support to be described later. In this case, the electric heating catalyst support may be arranged so that the electric heating catalyst support is not exposed from the tubular main body.

The surface (e.g., inner peripheral surface) of the tubular main body 110 may be subjected to surface treatment (not shown). A typical example of the surface treatment is roughening treatment such as blasting. Through the roughening treatment, adhesiveness of the insulating layer 120 and the intermediate layer 130 to the tubular main body 110 can be improved.

As a modified example of the tubular main body, there is given a tubular main body having a double structure including an outer tubular portion and an inner tubular portion that are arranged coaxially. In this case, the insulating layer may be arranged between the outer tubular portion and the inner tubular portion (on the inner peripheral surface of the outer tubular portion or the outer peripheral surface of the inner tubular portion), may be arranged on the inner peripheral surface of the inner tubular portion, or may be arranged at both of the above-mentioned positions.

Examples of the material (metal) for forming the tubular main body 110 include stainless steel, a titanium alloy, a copper alloy, an aluminum alloy, and brass. Of those, stainless steel is preferred because of high endurance reliability and low cost. Specific examples of the stainless steel include ferritic stainless steel, austenitic stainless steel, and martensitic stainless steel. Those materials may be used alone or in combination thereof. Typically, ferritic stainless steel (e.g., SUS430) is used.

The insulating layer 120 may impart an electrical insulating property between the tubular member 100 and the objects to be housed, such as a catalyst support to be described later. Herein, the electrical insulating property typically satisfies JIS standard D5305-3 from the viewpoint of suppressing the leakage of electricity to surrounding exhaust piping, and an insulation resistance value per unit voltage is, for example, 100 Ω/V or more. The insulating layer 120 preferably has moisture impermeability and moisture non-absorbability. Specifically, the insulating layer 120 is preferably configured to be so dense as to prevent the permeation and absorption of water. Regarding denseness, the insulating layer has a porosity of, for example, 10% or less, or for example, 8% or less.

The thickness of the insulating layer 120 is, for example, preferably 30 μm or more, more preferably 50 μm or more, still more preferably 100 μm or more, particularly preferably 150 μm or more from the viewpoint of obtaining an excellent insulating property. Meanwhile, the thickness of the insulating layer 120 is, for example, 800 μm or less, preferably 600 μm or less.

The insulating layer 120 contains glass. The composition of the glass is not particularly limited, and glasses having various compositions may be used. Specific examples of the glass include silicate glass, barium glass, boron glass, strontium glass, aluminosilicate glass, soda zinc glass, and soda barium glass. Those glasses may be used alone or in combination thereof.

The glass is preferably crystalline substance-containing glass. When the glass contains a crystalline substance, an insulating layer that is less liable to soften and deform even under high temperature (e.g., 750° C. or more) can be obtained. In addition, an insulating layer excellent in adhesiveness with the tubular main body can be obtained. Specifically, a difference in thermal expansion coefficient between the insulating layer and the tubular main body (metal) can be reduced, and hence a thermal stress occurring at the time of heating can be reduced. The presence or absence of the crystalline substance (crystal) may be determined by an X-ray diffraction method.

In at least one embodiment of the present invention, the glass contains silicon and boron. The glass may contain silicon in the form of SiO₂, and the glass may contain boron in the form of B₂O₃. Specifically, the glass may be SiO₂—B₂O₃-based glass (borosilicate glass). The content of silicon in the glass is preferably from 5 mol % to 50 mol %, more preferably from 7 mol % to 45 mol %, still more preferably from 10 mol % to 40 mol %. The content of boron in the glass is preferably from 5 mol % to 60 mol %, more preferably from 7 mol % to 57 mol %, still more preferably from 8 mol % to 55 mol %.

The glass may contain magnesium in addition to silicon and boron. The glass containing magnesium can satisfactorily achieve the crystalline substance. The glass may contain magnesium in the form of MgO. In this case, the content of magnesium in the glass is preferably 10 mol % or more, more preferably from 15 mol % to 55 mol %, still more preferably from 25 mol % to 52 mol %. The glass may contain another component (metal element), such as barium, lanthanum, zinc, calcium, aluminum, or strontium.

Herein, the “content of an element in the glass” is the molar ratio of atoms of the element in question with respect to 100 mol % of the amount of all atoms in the glass except oxygen atoms. The amount of atoms of each element in the glass is measured by, for example, inductively coupled plasma (ICP) emission spectrometry.

The thickness of the intermediate layer 130 is, for example, 35 μm or less, preferably 30 μm or less, and may be 25 μm or less, 15 μm or less, 5 μm or less, or 1 μm or less. Such thickness enables the securement of adhesiveness of the insulating layer to the tubular main body. Meanwhile, the thickness of the intermediate layer 130 is, for example, 10 nm or more.

The intermediate layer 130 has composition different from that of the insulating layer 120 (e.g., is substantially free of glass), and the composition of the intermediate layer 130 is at least not identical to the composition of the insulating layer 120. The intermediate layer 130 is typically formed of an oxide. Specifically, the intermediate layer 130 is formed of an oxide of at least one element selected from: aluminum; titanium; silicon; zirconium; magnesium; and yttrium. Of those, aluminum is preferably used. The content of aluminum in the intermediate layer is preferably more than 70 mol %, more preferably 75 mol % or more, and may be 80 mol % or more.

In at least one embodiment of the present invention, the intermediate layer contains a first element, which may also be contained in the insulating layer, and the content of the first element in the intermediate layer is higher than the content of the first element in the insulating layer. Examples of the first element include aluminum, magnesium, and silicon. The content of the first element in the insulating layer is, for example, 70 mol % or less. When the first element is aluminum, the content of the first element (aluminum) in the insulating layer is preferably 30 mol % or less, more preferably 20 mol % or less. When the first element is magnesium, the content of the first element (magnesium) in the insulating layer is preferably 65 mol % or less, more preferably 55 mol % or less. The content of the first element (magnesium) in the intermediate layer is, for example, more than 70 mol %, preferably 80 mol % or more. When the first element is silicon, the content of the first element (silicon) in the insulating layer is preferably 70 mol % or less, more preferably 50 mol % or less. The content of the first element (silicon) in the intermediate layer is, for example, more than 70 mol %. The content of each of the above-mentioned elements in the intermediate layer is the molar ratio of atoms of the element in question with respect to 100 mol % of the amount of all atoms in the intermediate layer except oxygen atoms, and the content of each of the above-mentioned elements in the insulating layer is the molar ratio of atoms of the element in question with respect to 100 mol % of the amount of all atoms in the insulating layer except oxygen atoms. Those contents may be measured by inductively coupled plasma (ICP) emission spectrometry.

### B. Manufacturing Method

A method of manufacturing the above-mentioned tubular member according to a first embodiment includes the steps of: applying an intermediate layer-forming material to at least an inner peripheral surface of a tubular main body made of a metal; and applying a coating liquid for insulating layer formation to the surface having applied thereto the intermediate layer-forming material, followed by firing of the resultant coating film to obtain an insulating layer.

The intermediate layer-forming material typically contains colloidal inorganic particles. Specifically, the intermediate layer-forming material contains colloidal inorganic particles, such as alumina sol, titania sol, silica sol, zirconia sol, magnesia sol, or yttria sol. The colloidal inorganic particles each have a particle diameter of preferably 20 μm or less, more preferably 10 μm or less.

Any appropriate method may be used as a method of applying the intermediate layer-forming material to the tubular main body. Specific examples of the application method include spraying, dipping, and bar coating. An application thickness may be adjusted in accordance with the above-mentioned desired thickness of the intermediate layer. The intermediate layer-forming material applied to the tubular main body (applied film) may be dried. A drying temperature is, for example, from 50° C. to 60° C. A drying time is, for example, from 5 minutes to 15 minutes.

Next, the coating liquid for insulating layer formation is applied to the surface having applied thereto the intermediate layer-forming material to form a coating film. The coating liquid for insulating layer formation is typically a slurry (dispersion) containing a glass source and a solvent. The coating liquid for insulating layer formation may contain raw materials or glass frit as the glass source. In at least one embodiment of the present invention, the coating liquid for insulating layer formation is obtained by producing glass frit from raw materials and mixing the resultant glass frit with the solvent. Herein, the “solvent” refers to a liquid medium contained in the coating liquid for insulating layer formation, and is a concept encompassing solvent and dispersion medium.

Specific examples of the raw material include silica sand (silicon source), dolomite (magnesium and calcium source), alumina (aluminum source), boric acid, barium oxide, lanthanum oxide, zinc oxide (zinc flower), and strontium oxide. The raw material is not limited to an oxide, and may also be, for example, a carbonate or a hydroxide. The glass frit is typically obtained by pulverizing glass produced by synthesis from raw materials (e.g., pulverizing the glass in two stages of coarse pulverization and fine pulverization). The synthesis is typically performed by melting under high temperature (e.g., 1,200° C. or more) for a long period of time.

The solvent may be water or an organic solvent. The solvent is preferably water or a water-soluble organic solvent such as an alcohol, and is more preferably water. The blending amount of the solvent is, for example, preferably from 30 parts by mass to 300 parts by mass, more preferably from 50 parts by mass to 200 parts by mass with respect to 100 parts by mass of the glass source.

The coating liquid for insulating layer formation (slurry) may contain a slurry aid. Examples of the slurry aid include a resin, a plasticizer, a dispersant, a thickener, and various other additives. The kinds, number, combination, blending amounts, and the like of the slurry aids may be appropriately set in accordance with purposes.

Any appropriate method may be used as a method of applying the coating liquid for insulating layer formation. Specific examples of the application method include spraying, dipping, and bar coating. An application thickness may be adjusted in accordance with the above-mentioned desired thickness of the insulating layer. The applied coating liquid for insulating layer formation may be dried. A drying temperature is, for example, from 40° C. to 120° C., and for example, from 50° C. to 110° C. A drying time is, for example, from 1 minute to 60 minutes, and for example, from 10 minutes to 30 minutes.

As described above, the resultant coating film may be fired to form the insulating layer. A firing temperature is preferably 1,100° C. or less, more preferably 1,050° C. or less, still more preferably 1,000° C. or less, and may be 950° C. or less, or 900° C. or less. In at least one embodiment of the present invention, the firing temperature is set to, for example, a temperature lower than the heat-resistant temperature of the tubular main body. Meanwhile, the firing temperature is preferably 600° C. or more, more preferably 700° C. or more. A firing time is, for example, from 5 minutes to 30 minutes, and may be from 8 minutes to 15 minutes.

In the firing of the coating film, the applied film of the intermediate layer-forming material may also be fired to form the intermediate layer between the tubular main body and the insulating layer. Thus, the intermediate layer and the insulating layer may be fixed to the tubular main body.

A method of manufacturing the above-mentioned tubular member according to a second embodiment includes a step of applying a coating liquid for insulating layer formation to at least an inner peripheral surface of a tubular main body made of a metal, the tubular main body containing an intermediate layer-forming component, followed by firing of the resultant coating film to obtain an insulating layer.

The intermediate layer-forming component may be appropriately selected in accordance with the desired intermediate layer. As the intermediate layer-forming component, for example, aluminum, titanium, silicon, zirconium, magnesium, or yttrium is used. Of those, aluminum is preferably used. The content of the intermediate layer-forming component in the material for forming the tubular main body (before the firing) is, for example, from 0.1 mass % to 5 mass %, preferably from 0.5 mass % to 3 mass %.

The coating liquid for insulating layer formation, a method of forming the coating film thereof, and the firing are as described in the first embodiment.

In the second embodiment, through the firing, the intermediate layer-forming component may precipitate on the surface of the tubular main body to form a film (e.g., an oxide film). As a result, in the region in which the coating liquid for insulating layer formation has been applied, the intermediate layer may be formed between the tubular main body and the insulating layer. The thickness of the intermediate layer that may be obtained according to this embodiment is preferably 1 μm or less. Even with such thickness, high insulation durability can be achieved. The lower limit of the thickness of the intermediate layer is not particularly limited, but is, for example, 10 nm or more as described above.

### C. Usage Example

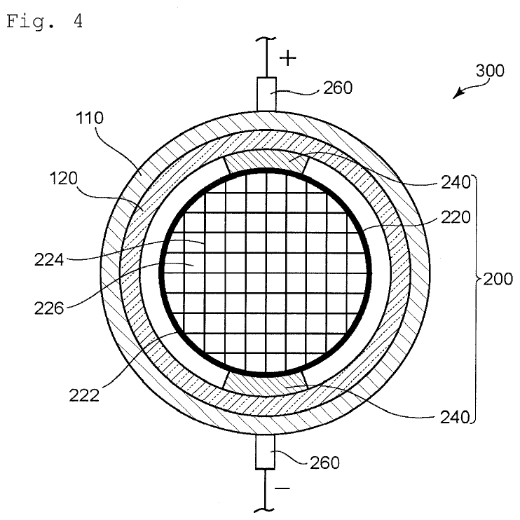

FIG. 3 is a schematic sectional view for illustrating the schematic configuration of the exhaust gas treatment device according to at least one embodiment of the present invention, and FIG. 4 is a view of an exhaust gas treatment device 300 of FIG. 3 seen from the direction of the arrow IV. The exhaust gas treatment device 300 is installed in a flow path through which an exhaust gas from an engine is to be flowed. In FIG. 3, as indicated by the arrow EX, the exhaust gas flows from left to right in the exhaust gas treatment device 300. In FIG. 3 and FIG. 4, the insulating layer and the intermediate layer are illustrated as an inner structural layer 140.

The exhaust gas treatment device 300 includes the tubular member 100 and an electric heating catalyst support (hereinafter sometimes referred to simply as “catalyst support”) 200 housed in the tubular member 100 and capable of heating the exhaust gas.

The catalyst support 200 has a shape corresponding to the shape of the tubular member 100, and is coaxially housed in the tubular member 100. The catalyst support 200 is housed so as to be brought into contact with the inner peripheral surface of the tubular member 100, but may be, for example, housed under a state in which the outer peripheral surface of the catalyst support 200 is covered with a holding mat (not shown).

The catalyst support 200 includes a honeycomb structure portion 220 and a pair of electrode layers 240 arranged on a side of the honeycomb structure portion 220 (typically so as to be opposed to each other across a central axis of the honeycomb structure portion). The honeycomb structure portion 220 includes an outer peripheral wall 222 and partition walls 224 which are arranged on an inner side of the outer peripheral wall 222 and which define a plurality of cells 226 extending from a first end surface 228a to a second end surface 228b to form the exhaust gas flow path. The outer peripheral wall 222 and the partition walls 224 are typically formed of conductive ceramics. The pair of electrode layers 240 and 240 are provided with terminals 260 and 260, respectively. One terminal is connected to a positive electrode of a power supply (e.g., a battery), and the other terminal is connected to a negative electrode of the power supply. On the periphery of the terminals 260 and 260, covers 270 and 270 each made of an insulating material are arranged so as to insulate the tubular member 100 from the terminals 260.

The catalyst is typically supported on the partition walls 224. When the catalyst is supported on the partition walls 224, CO, NOR, a hydrocarbon, and the like in the exhaust gas passing through the cells 226 can be formed into harmless substances by a catalytic reaction. The catalyst may preferably contain a noble metal (e.g., platinum, rhodium, palladium, ruthenium, indium, silver, or gold), aluminum, nickel, zirconium, titanium, cerium, cobalt, manganese, zinc, copper, tin, iron, niobium, magnesium, lanthanum, samarium, bismuth, barium, and a combination thereof.

### EXAMPLES

The present invention is specifically described below by way of Examples, but the present invention is not limited by these Examples. A measurement method for an arithmetic average roughness Ra is as described below, unless otherwise stated.

### <Arithmetic Average Roughness Ra>

The arithmetic average roughness Ra is a value obtained through measurement in an interval from 0.5 cm to 1.5 cm with a surface roughness-measuring machine.

### Example 1-1

A flat plate made of SUS430 was subjected to sandblasting treatment using #24 to #60 alumina abrasive grains. A treatment time was set to 1 minute. The arithmetic average roughness Ra of the flat plate after the sandblasting treatment was from 2.0 μm to 6.5 μm. Next, alumina sol (“ALUMINASOL 200” manufactured by Nissan Chemical Industries, Ltd.) was applied to the sandblasted surface by spraying, and the resultant applied film was dried to be held on the flat plate.

100 Parts by mass of water was added to 100 parts by mass of borosilicate glass powder, and wet mixing was performed in a ball milling apparatus to provide a slurry. The slurry was applied by spraying onto the applied film of the alumina sol on the flat plate, and was dried. After that, firing was performed under air by keeping the flat plate at 860° C. for 10 minutes, to thereby form an alumina layer (thickness: 5 μm) and a glass layer (thickness: 400 μm) on the flat plate. Thus, an evaluation sample was obtained. The laminated structure of the alumina layer and the glass layer, and the thickness of each layer were observed by cross-sectional scanning electron microscopy (SEM) or measured with an electromagnetic film thickness meter after lamination.

### Example 1-2

An evaluation sample was obtained in the same manner as in Example 1-1 except that an alumina layer having a thickness of 10 μm was formed.

### Example 1-3

An evaluation sample was obtained in the same manner as in Example 1-1 except that an alumina layer having a thickness of 20 μm was formed.

### Example 1-4

An evaluation sample was obtained in the same manner as in Example 1-1 except that an alumina layer having a thickness of 30 μm was formed.

### Example 2-1

A ferritic stainless steel (SUS430) alloy flat plate containing 2 mass % of aluminum was subjected to sandblasting treatment using #24 to #60 alumina abrasive grains. A treatment time was set to 1 minute. The arithmetic average roughness Ra of the flat plate after the sandblasting treatment was from 2.0 μm to 6.5 μm.

100 Parts by mass of water was added to 100 parts by mass of borosilicate glass powder, and wet mixing was performed in a ball milling apparatus to provide a slurry. The slurry was applied by spraying onto the sandblasted surface of the flat plate, and was dried. After that, firing was performed under air by keeping the flat plate at 860° C. for 10 minutes, to thereby form an alumina layer (thickness: less than 1 μm) and a glass layer (thickness: 400 μm) in the stated order on the flat plate. Thus, an evaluation sample was obtained. The observation of the formation of the alumina layer and the measurement of the thickness of the glass layer were performed by cross-sectional SEM observation of a laminated state.

### Example 2-2

An evaluation sample was obtained in the same manner as in Example 2-1 except that a ferritic stainless steel (SUS430) alloy flat plate containing 3 mass % of aluminum was used.

### Comparative Example 1

An evaluation sample was obtained in the same manner as in Example 1-1 except that the alumina layer (intermediate layer) was not formed.

The following evaluation was performed for each of Examples and Comparative Example.

### <Evaluation>

The obtained evaluation sample was placed in an electric furnace and heated at 900° C. Every 5 hours from the start of the heating, the evaluation sample was taken out, and its insulating property was determined by measuring the insulation resistance value of the glass layer. The time required for the insulation resistance value to become 100 Ω/V or less is shown in Table 1.

TABLE 1

| | | Start of insulation |
|---|---|---|
| | Intermediate layer | deterioration |
| | Thickness (μm) | (Hours) |
| Example 1-1 | 5 | 10 |
| Example 1-2 | 10 | 15 |
| Example 1-3 | 20 | 20 |
| Example 1-4 | 30 | 20 |
| Example 2-1 | ≤1 | 20 |
| Example 2-2 | ≤1 | 20 |
| Comparative Example 1 | — | 5 |

In Comparative Example 1, the evaluation sample after 5 hours from the start of the heating was subjected to analysis by energy dispersive X-ray spectroscopy (EDX analysis), and as a result, the presence of a component derived from the flat plate (SUS) (component of which the alumina layer and the glass layer were originally substantially free) was recognized in the glass layer.

In each Example, it is found that the insulating property can be satisfactorily kept.

The tubular member for an exhaust gas treatment device according to at least one embodiment of the present invention can be suitably used for the treatment (purification) of an exhaust gas from an internal combustion engine.

According to at least one embodiment of the present invention, the tubular member for an exhaust gas treatment device excellent in insulation durability can be obtained.

What is claimed is:

1. A tubular member for an exhaust gas treatment device, comprising:
a tubular main body made of a metal;
an insulating layer arranged at least on an inner peripheral surface side of the tubular main body; and
an intermediate layer arranged between the tubular main body and the insulating layer,
wherein the insulating layer contains glass, and
wherein the intermediate layer is at least not identical in composition to the insulating layer.

2. The tubular member for an exhaust gas treatment device according to claim 1, wherein the tubular main body is formed of ferritic stainless steel.

3. The tubular member for an exhaust gas treatment device according to claim 1, wherein the intermediate layer is formed of an oxide.

4. The tubular member for an exhaust gas treatment device according to claim 3, wherein the intermediate layer is formed of an oxide of at least one element selected from: aluminum; titanium; silicon; zirconium; magnesium; and yttrium.

5. The tubular member for an exhaust gas treatment device according to claim 1,
wherein the intermediate layer and the insulating layer each contain a first element, and
wherein a content of the first element in the intermediate layer is higher than a content of the first element in the insulating layer.

6. The tubular member for an exhaust gas treatment device according to claim 5, wherein the content of the first element in the insulating layer is 70 mol % or less.

7. The tubular member for an exhaust gas treatment device according to claim 5, wherein the first element is aluminum.

8. The tubular member for an exhaust gas treatment device according to claim 1, wherein the intermediate layer is substantially free of glass.

9. The tubular member for an exhaust gas treatment device according to claim 1, wherein the glass contained in the insulating layer contains silicon, boron, and magnesium.

10. The tubular member for an exhaust gas treatment device according to claim 1, wherein the insulating layer has a thickness of 30 μm or more and 800 μm or less.

11. The tubular member for an exhaust gas treatment device according to claim 1, wherein the intermediate layer has a thickness of 30 μm or less.

12. The tubular member for an exhaust gas treatment device according to claim 1, wherein the intermediate layer has a thickness of 1 μm or less.

13. A method of manufacturing the tubular member for an exhaust gas treatment device of claim 1, the method comprising:
applying an intermediate layer-forming material to an inner peripheral surface of a tubular main body made of a metal; and
applying a coating liquid for insulating layer formation to the surface having applied thereto the intermediate layer-forming material, followed by firing of the resultant coating film to obtain an insulating layer.

14. A method of manufacturing the tubular member for an exhaust gas treatment device of claim 1, the method comprising applying a coating liquid for insulating layer formation to an inner peripheral surface of a tubular main body made of a metal, the tubular main body containing an intermediate layer-forming component, followed by firing of the resultant coating film to obtain an insulating layer.

15. An exhaust gas treatment device, comprising:
an electric heating catalyst support capable of heating an exhaust gas; and
the tubular member for an exhaust gas treatment device of claim 1 configured to house the electric heating catalyst support.
